(19) United States
(12) Patent Application Publication
(10) Pub. No.: US 2009/0048126 A1
(43) Pub. Date: Feb. 19, 2009

(54) Method of Treating Formation With Polymer Fluids

(76) Inventors: Alhad Phatak, Houston, TX (US); Michael D. Parris, Richmond, TX (US); Yenny Christanti, Houston, TX (US); Balkrishna Gadiyar, Katy, TX (US); Philip F. Sullivan, Bellaire, TX (US); Carlos Abad, Richmond, TX (US)

Correspondence Address: SCHLUMBERGER TECHNOLOGY CORPORATION;David Cate, IP DEPT., WELL STIMULATION, 110 SCHLUMBERGER DRIVE, MD1, SUGAR LAND, TX, 77478, US

(21) Appl. No.: 12/176,972

(22) Filed: Jul. 21, 2008

Related U.S. Application Data
(60) Provisional application No. 60/956,412, filed on Aug. 17, 2007.

(51) Int. Cl. C09K 8/68

(52) U.S. Cl. 507/209; 507/219

(57) ABSTRACT

A method of treating a subterranean formation penetrated by a wellbore is carried out by providing a treatment fluid comprising a hydratable polymer, a divalent metal salt in an amount of at least about 0.25 mol/L and an aluminum crosslinking agent. The fluid is provided with a pH of from about 5 or higher. The treatment fluid may be caused to contact the formation by introducing the fluid into the wellbore. The fluid may optionally contain a polyol.

### CROSS-REFERENCE TO RELATED APPLICATIONS

This application claims the benefit of U.S. Provisional Patent Application No. 60,956,412, filed Aug. 17, 2007, which is hereby incorporated herein by reference in its entirety.

### BACKGROUND

The statements in this section merely provide background information related to the present disclosure and may not constitute prior art.

This invention relates to fluids used in treating a subterranean formation. In particular, the invention relates to the use of aluminum crosslinking agents for crosslinking hydratable polymers in divalent heavy brine based wellbore treatment fluids, and methods of forming and using such fluids.

Hydraulic fracturing is a process of stimulating oil and natural gas reservoirs by creating and propping fractures in the formation around an existing well bore. This is typically accomplished by pumping a fluid (containing suspended solids called proppants, e.g. sand) at high enough rates to create fractures in the formation; after the fracture is created the fluid is withdrawn (flowed back to the surface) leaving the proppant in the fracture, and the fracture is held open. Hydraulic fracturing creates highly conductive channels (compared to the formation) for oil and natural gas to flow into the well bore, thereby increasing productivity of the well.

Another operation that requires a fluid to successfully carry solids to a target area is gravel packing. In this operation, strategically sized gravel particles are deposited in the near-wellbore region. Gravel packs are created to act as “filters” that prevent formation sand from entering the well bore during production; this is specifically performed in unconsolidated or weakly consolidated sandstone formations. Frac-and-pack operations are performed wherein short and wide fractures are created to bypass the (potentially damaged) near well bore region, followed by deposition of a gravel pack for sand control. Viscosity is typically generated in aqueous stimulation fluids by employing crosslinked high molecular weight polymers and viscoelastic surfactants.

To prevent settling of the proppant during transport, the carrier fluid has to have desirable rheological properties (e.g. high viscosity, high elastic modulus). Fluid viscosity is vital for effective proppant placement during fracturing and other operations. Polysaccharides such as guar and guar derivatives have historically served as the most common viscosity enhancers. They are often crosslinked using borates or metallic crosslinkers such as zirconium and titanium to generate even higher viscosity.

A major challenge in hydraulic fracturing or gravel packing operations is the need to reduce the surface treating pressure to stay within current equipment operating limits. One way to address this pressure limitation without changing the pump rate is by increasing the hydrostatic pressure. The surface treating pressure (P_{surface}) can be reduced by using the hydrostatic head (P_{hydrostatic}) provided by using heavy brines (e.g. heavy brines composed of water and a variety of salts) to formulate the fluid, as represented in Equation 1 below. Here, P_{BHP} refers to the treating pressure at the point where the fracture is being created, and P_{friction} refers to the fluid friction pressure between the surface and formation.

P_{surface}=P_{BHP}+P_{friction}−P_{hydrostatic} (1)

Higher hydrostatic head can be achieved by using heavy brines which have much higher densities than conventional fracturing fluids. The weighted fluids used for stimulation have thus far been formulated with sodium bromide (NaBr) brine. These are typically guar and derivatized guar dissolved in sodium bromide brine and crosslinked with borate crosslinking agents.

Calcium chloride and calcium bromide brines are more readily available compared to sodium bromide brine, and thus less costly. In addition, the maximum density of calcium bromide brine (˜14.2 lb/gal or ˜1.7 kg/L) is higher than that of sodium bromide (˜12.5 lb/gal or ˜1.5 kg/L). Therefore, a weighted fracturing fluid that can be formulated in calcium salt brines may be more desirable.

Divalent cations, such as those from calcium salt brines, however, inhibit hydration of the guar or other polymers. Crosslinking guar or other polymers in divalent brines, such as calcium chloride and calcium bromide brines, is also not trivial. The addition of a pH buffer to divalent brines is known to cause hydroxide precipitation. Further, potential precipitation of calcium hydroxide limits the pH to which they can be buffered, rendering the commonly employed borate crosslinking ineffective, especially at high temperature. As an example, precipitation of calcium hydroxide limits the pH of 10 ppg (1.2 kg/L) calcium chloride brine to a pH of less than 10.

Zirconium and titanium-crosslinked guars are less sensitive to pH and display high temperature stability. Such zirconium and titanium-crosslinked fluids are shear sensitive and prone to degradation when subjected to high shear, however. As a result, a Zr— or Ti-crosslinked fluids may lose viscosity while being pumped into the well bore (usually a region of high shear rate). Furthermore, while methods to delay the crosslinking are available, it may be difficult to precisely trigger the crosslinking reaction at the desired location in the formation. This is especially true when delaying the crosslinking with carboxylic acid and amine chelants, which may be inadequate due to the abundance of calcium ions in solution.

What are therefore needed are methods and treatment fluids that overcome these limitations.

### SUMMARY

A method of treating a subterranean formation penetrated by a wellbore is accomplished by forming a treatment fluid comprising a hydratable polymer, a divalent metal salt in an amount of at least about 0.25 mol/L and an aluminum crosslinking agent and providing the fluid with a pH of from about 5 or higher and causing the treatment fluid to contact the formation. The fluid may further contain a proppant in certain applications.

In certain embodiments, the treatment fluid further comprises a polyol. Where a polyol is used, the polyol may be provided from arabinose, fructose, mannitol, ribose, sorbitol, xylose, gluconic acid and its salts, glucoheptonic acid and its salts, and combinations of these. The polyol may be present in an amount of from about 10 to 100 ppt (1.2 g/L to 12 g/L).

The divalent metal salt may be provided from at least one of a calcium salt and a zinc salt, such as calcium bromide, calcium chloride and zinc bromide. Further, the pH of the fluid may be from about 7 to about 9.5, in certain applications.

The treatment fluid may be used to 1) reduce pressure output requirements of surface equipment, 2) to prevent or reduce hydrate formation within the formation, 3) to limit lost fluid circulation or 4) to block or plug water-rich zones of the formation.

The aluminum crosslinking agent may be provided from sodium aluminate, aluminum chloride, aluminum bromide, aluminum fluoride, aluminum iodide, aluminum carbide, aluminum ethoxide, aluminum isopropoxide, aluminum stearate, aluminum oxide, aluminum phosphate, bauzite (containing aluminum hydroxide (gibbsite), boehmite, kaolinite, diaspore), various aluminosilicates, aluminum lactate, aluminum acetate, aluminum citrate, aluminum chlorohydrate, aluminum chloride hexahydrate, aluminum acetyl acetonate, ammonium aluminum sulfate and aluminum metal. The aluminum crosslinking agent may be provided in an amount of from about 1 to about 1000 parts per million of active aluminum by weight of the treatment fluid.

In yet another embodiment of the invention, related to so called “frac-pack” operations, a first aqueous treatment fluid containing a hydratable polymer, a divalent metal salt, and an aluminum crosslinking agent, is prepared and introduced into the wellbore. This fluid makes contact at a target zone, with a pressure equal to or greater than the fracture initiation pressure of the formation, thereby causing at least one fracture in the formation. A second treatment fluid formed of an aqueous medium, a hydratable polymer, a divalent metal salt, a gravel component, and an aluminum crosslinking agent, is introduced into the wellbore to subsequently form a gravel pack in the fracture formed in the formation.

### BRIEF DESCRIPTION OF THE DRAWINGS

For a more complete understanding of the present invention, and the advantages thereof, reference is now made to the following descriptions taken in conjunction with the accompanying figures, in which:

FIG. 1 is a plot of viscosities at different shear rates and pH levels of various hydroxypropyl guar gels employing an aluminum crosslinking agent in deionized water compared to a similar gel prepared in a calcium chloride brine;

FIG. 2a is a plot of the dynamic elastic (G′) and viscous (G″) moduli of hydroxypropyl guar gels containing an aluminum crosslinking agent at different frequencies before and after the addition of calcium chloride;

FIG. 2b is a plot of the viscosities of the fluids from FIG. 2a at different shear rates;

FIG. 3 is a plot of the dynamic elastic (G′) and viscous (G″) moduli of different gelled fluids at different frequencies prepared with an aluminum crosslinking agent in calcium chloride brines;

FIG. 4 is a plot of the dynamic elastic (G′) and viscous (G″) moduli of a hydroxypropyl guar gel containing an aluminum crosslinking agent prepared in a calcium chloride/calcium bromide brine at different frequencies;

FIG. 5 is a plot of the viscosity of an aluminum-crosslinked hydroxypropyl guar fluids prepared in a calcium chloride brine through a series of shear ramps at different temperatures over time;

FIG. 6 is a plot of the dynamic elastic (G′) and viscous (G″) moduli of a hydroxypropyl guar gelled fluid prepared with an aluminum chloride hexahydrate crosslinking agent in a calcium chloride brine with a pH modifier;

FIG. 7 is a plot of the dynamic elastic (G′) and viscous (G″) moduli of a hydroxypropyl guar gelled fluid prepared with an aluminum lactate crosslinking agent in a calcium chloride brine with a pH modifier;

FIG. 8 is a plot of the shear history of an aluminum-crosslinked carboxymethylhydroxypropyl guar (CMHPG) prepared in a calcium chloride brine without any polyol;

FIG. 9 is a plot of the shear history of an aluminum-crosslinked carboxymethylhydroxypropyl guar (CMHPG) prepared in a calcium chloride brine with a polyol of sodium gluconate;

FIG. 10 is a plot of the viscosity of an aluminum-crosslinked carboxymethylhydroxypropyl guar (CMHPG) prepared in a calcium chloride brine with sorbitol at a single shear rate over time;

FIG. 11 is a plot of the viscosity of an aluminum-crosslinked carboxymethylhydroxypropyl guar (CMHPG) prepared in a calcium chloride brine with a polyol of sodium gluconate and a high temperature stabilizer at a single shear rate over time at a temperature of approximately 126° C.;

FIG. 12 is a plot of the shear history of an aluminum-crosslinked hydroxypropl guar prepared in a calcium chloride brine with and without sodium gluconate; and

FIG. 13 is a plot of the shear history of an aluminum-crosslinked carboxymethylhydroxypropyl guar (CMHPG) prepared in a calcium chloride brine with and without sorbitol.

### DESCRIPTION OF THE INVENTION

The description and examples are presented solely for the purpose of illustrating the different embodiments of the invention and should not be construed as a limitation to the scope and applicability of the invention. While the compositions of the present invention are described herein as comprising certain materials, it should be understood that the composition could optionally comprise two or more chemically different materials. In addition, the composition can also comprise some components other than the ones already cited. In the description, each numerical value should be read once as modified by the term “about” (unless already expressly so modified), and then read again as not so modified unless otherwise indicated in context. Also, in the description, it should be understood that a range, such as a concentration range, listed or described as being useful, suitable, or the like, is intended that any and every value within the range, including the end points, is to be considered as having been stated. For example, “a range of from 1 to 10” is to be read as indicating each and every possible number along the continuum between about 1 and about 10. Thus, even if specific data points within the range, or even if no data points within the range, are explicitly identified or refer to only a few specific data points, it is to be understood that the inventors appreciate and understand that any and all data points within the range are to be considered to have been specified, and that inventors are in possession of the entire range and all points within the range.

The present invention makes use of aluminum crosslinking agents for crosslinking hydratable polymers in divalent heavy brines. Aluminum crosslinking agents are known for use in crosslinking guar and other hydratable polymers. Such aluminum crosslinking agents have been used in monovalent salt brines with low pH. The aluminum crosslinking agents only weakly crosslink the hydratable polymers, such as polysaccharides, in water, however. When used in combination with divalent metal salts, such as calcium salts, it has been unexpectedly observed that strong gels are obtained. And contrary to those methods where aluminum crosslinking agents are used with monovalent salts, stronger gels are obtained in the divalent brines where the pH of the fluid is from about 5 or higher. In particular, strong divalent brine gels may be prepared with a pH of from about 7 to about 10. In some applications the pH may be from about 7.5 to about 8 or 9.5 depending upon the brine density.

The aluminum crosslinking agent may be provided from any organic or inorganic component that provides aluminum-containing ions in solution that facilitate crosslinking of the hydratable polymer. These may include alkali metal aluminates, such as sodium aluminate, although other aluminum salts may be used as well. Examples of suitable aluminum crosslinking agents include sodium aluminate, aluminum chloride, aluminum bromide, aluminum fluoride, aluminum iodide, aluminum carbide, aluminum ethoxide, aluminum isopropoxide, aluminum stearate, aluminum oxide, aluminum phosphate, bauxite (which contains aluminum hydroxide (gibbsite), boehmite, kaolinite, diaspore), various aluminosilicates, aluminum lactate, aluminum acetate, aluminum citrate, aluminum chlorohydrate, aluminum acetyl acetonate and ammonium aluminum sulfate or combinations of these. The crosslinking agents may be salts that are highly soluble in water, or slow dissolving salts that release aluminum as they dissolve. Additionally, the aluminum crosslinking agent may be provided from an aluminum-containing compound, which may be incorporated in or coated on a solid substrate or particles wherein the aluminum facilitates crosslinking of the polymers.

The aluminum crosslinking agent may be used in an amount of the fluids described herein that provides from about 1 to about 1000 parts per million or more of active aluminum by weight of the fluid, more particularly from about 5 to about 750 parts per million of active aluminum by weight of the fluid, and still more particularly from about 10 to about 500 parts per million of active aluminum by weight of the fluid.

The aluminum crosslinking agent may be used alone or in combination with other crosslinking agents. These may include those that comprise a chemical compound containing a polyvalent metal ion such as, but not necessarily limited to, chromium, iron, boron, titanium, hafnium, antimony and zirconium metal ions. The total amount of crosslinking agents may be used in an amount of the fluids described herein that provides from about 1 to about 1000 parts per million or more of active metal by weight of the fluid, more particularly from about 5 to about 750 parts per million of active metal by weight of the fluid, and still more particularly from about 10 to about 500 parts per million of active metal by weight of the fluid.

The aluminum crosslinking agent, alone or in combination with other crosslinking agents, is used in crosslinking a hydratable or solvatable polymer for forming a crosslinked gelled fluid. Any useful polymer may be used. The hydratable polymer may be a polysaccharide polymer. The polysaccharide polymer may include, but is not limited to, guar gums, high-molecular weight polysaccharides composed of mannose and galactose sugars, or guar derivatives such as hydropropyl guar (HPG), carboxymethyl guar (CMG), and carboxymethylhydroxypropyl guar (CMHPG). Cellulose derivatives such as hydroxyethylcellulose (HEC) or hydroxypropylcellulose (HPC) and carboxymethylhydroxyethylcellulose (CMHEC) may also be used. The polysaccharide may be cationic, anionic or non-ionic. Cationic polysaccharides may include guar (and guar derivatives), cellulose (and cellulose derivatives), that are further substituted with chemical groups capable of providing positively charged sites on the polymer. Reaction with quaternary ammonium compounds is a common method to obtain cationic polysaccharides. U.S. Pat. No. 4,663,159 provides details about various cationic polysaccharides. Xanthan, diutan, and scleroglucan, three biopolymers, have been shown to be useful as the hydratable polymers. Also, associative polymers for which viscosity properties are enhanced by suitable surfactants and hydrophobically modified polymers can be used, such as cases where a charged polymer in the presence of a surfactant having a charge that is opposite to that of the charged polymer, the surfactant being capable of forming an ion-pair association with the polymer resulting in a hydrophobically modified polymer having a plurality of hydrophobic groups, as described in published application U.S. 20040209780A1, Harris et. al. The polysaccharide polymers may have an average molecular weight of at least 100,000 or more.

The hydratable polymer may also include polyvinyl alcohol homopolymers and copolymers. As used herein, homopolymers is meant to encompass those polymers having less than about 0.001% by weight of any other monomers incorporated into the polymer chain. The copolymers may be random or block copolymers incorporating one or more different monomers.

The fluids of the invention incorporate a divalent brine. The divalent brine may be formed from divalent metal ions such as calcium, magnesium, zinc, barium, beryllium, copper chromium, cobalt, lead, strontium, tin, manganese and iron. The salts used herein may contain organic as well as inorganic ions. Particularly well suited are the divalent salts of calcium and zinc. These may include their halide salts, such as calcium chloride, calcium bromide and zinc bromide. The divalent metal salt is used in an amount of from about 0.25 mol/L or more. The amount of divalent metal salt used may be any amount and include any amount up to and beyond that of its saturation point for the given environmental temperature and pressure conditions. In certain applications, the amount of divalent salt used may be above that of its saturation point wherein crystallized or solid salts may initially exist or precipitate within the fluid. This excess of salt may subsequently dissolve within the fluid as the conditions of the fluid change. Thus, at surface conditions, amounts of the crystallized salt may be present in the fluid. Upon introduction of the fluid into the formation, however, where temperatures may be higher than the crystallization point for the salt concentration, the additional salt will dissolve and enter into solution.

The use of divalent metal salts allows higher density fluids to be prepared. The use of the divalent heavy brines increases the amount of hydrostatic head provided, as discussed in the background section, and reduces the amount of pressure that must be used with the well equipment. The density of the divalent brine fluids of the invention may be 8.5 lbs/gal (1 kg/L) or more. In certain applications the density of the fluid of the invention may be between 9 lbs/gal (1.078 kg/L) to 21 lbs/gal (2.52 kg/L). Examples of densities for different brines and combinations of brines are presented in MI Swaco's Completion Fluids Manual, dated 2005, which is herein incorporated by reference in its entirety for all purposes.

The fluids of the invention may also include other monovalent salts, as well. These may be the monovalent salts of sodium chloride, potassium chloride, ammonium chloride, sodium bromide, sodium formate, potassium formate, cesium formate, sodium carbonate, and sodium bicarbonate salts, and the like. Any mixtures of these monovalent salts may be used as well in combination with the divalent salts discussed. The salts may aid in the development of increased viscosity that is characteristic of the desired fluids. Further, the salts may assist in maintaining the stability of a geologic formation to which the fluid is exposed. Formation stability and in particular clay stability (by inhibiting hydration of the clay) is achieved at a concentration level of a few percent by weight and as such the density of fluid is not significantly altered by the presence of the inorganic salts unless fluid density becomes an important consideration, at which point, heavier or larger amounts of the inorganic salts may be used. In some embodiments of the invention, an organic salt such as tetramethyl ammonium chloride may be incorporated into the fluid. The monovalent salts may be used in any amount. A typical amount may be from about 0.01 wt % to about 25.0 wt % of the fluid.

It should be pointed out that all percentages or amounts presented herein are based upon weight unless expressly indicated otherwise or as is readily apparent from the context. Further, all percentages or amounts based upon weight of the treatment fluid are based upon the liquid or non-gas phase of the fluid. If the percentage or amount is presented as based upon volume, this is also based upon the volume of the liquid or non-gas phase of the fluid unless expressly indicated otherwise or as is readily apparent from the context.

During hydration of the polymer, the polymer may be hydrated in the heavy brine itself with all or substantially all of the salts incorporated into the fluid. In some instances, however, the polymer may be initially hydrated in water or a relatively low density brine, and the density of the mixture may be subsequently increased by adding higher density brine to the hydrated polymer solution or by the addition of dry salts that are then dissolved within the fluid. Yet, in some other instances, the polymer may be initially hydrated in an aqueous medium which may be essentially free of divalent salt, or at least sufficiently low enough, such that when the fluid is prepared it is significantly low in viscosity and introduced into a wellbore; and, thereafter, a divalent salt is mixed with the fluid resulting in an increase in fluid viscosity.

An acid may also be added to the fluid to speed up hydration of the polymer in the brine. Any acid capable of lowering the pH may be used provided it creates no detrimental effects to the fluid or the formation being treated. The acid may be used in various amounts to provide a pH of from about 1 to about 7. The amount of acid used may be dependent upon the amount of salts in solution. Examples of suitable acids include hydrochloric acid, sulfuric acid, nitric acid, phosphoric acid, chromic acid, acetic acid, formic acid, citric acid, methanesulfonic acid, ethanesulfonic acid, benzenesulfonic acid, toluenesulfonic acid, etc. A pH buffer or pH modifier may also be added to the fluid. These may be used to adjust or raise the pH of the fluid to facilitate crosslinking of the heavy brine polymer fluid, which may have an initially low pH to facilitate polymer hydration. These may include an amine compound, such as an organoamino compound. Examples of suitable organoamino compounds include, but are not necessarily limited to, tetraethylenepentamine, triethylenetetramine, pentaethylenehexamine, triethanolamine, and the like, or any mixtures thereof. These compounds may also act as high temperature stabilizers that prevent degradation of the polymer at high temperatures. When organoamino compounds are used in fluids of the invention, they may be incorporated in an amount from about 0.01 wt % to about 2.0 wt % based on total liquid phase weight, more particularly, the organoamino compound may be incorporated at an amount from about 0.05 wt % to about 1.0 wt % based on total liquid phase weight. A particularly useful organoamino compound is tetraethylenepentamine. Other pH buffers or pH modifiers may be used as well. These may include diethanolamine, triethanolamine, dimethylethanolamine, diethylenetriamine, triethylenetetramine, pentaethylenehexamine, etc. In certain applications, the aluminum crosslinking agent itself may act as a pH modifier. This is true in the case of sodium aluminate, for instance.

The fluid may optionally include a polyol. Polyols have been found to delay the crosslinking of polymers by aluminum crosslinking agents in divalent heavy brines, such as calcium salt brines. While the polyols may result in lower viscosity of the gels when not subjected to high shear, recovery of viscosity after application of high shear of the fluids is higher with the use of polyols.

Polyols, as used herein, are those organic compounds having two or more hydroxyl (—OH) groups. In particular, the polyols may have adjacent hydroxyl groups in a cis-orientation, i.e. cis-hydroxyls, or non-adjacent hydroxyl groups. The polyols are capable of complexing with the aluminum crosslinking agent to thereby delay polymer crosslinking. The polyols may comprise such materials as natural, modified or synthetic saccharides, including monosaccharides, reduced monosaccharides, oligosaccharides having a molecular weight up to about 2,000, and polysaccharides including natural and synthetic gums and other polyhydroxy containing compounds such as oligovinyl alcohol, and copolymers. Also included in the term “polyols” are the acid, acid salt, ester, hydrogenation and amine derivatives of the polyol so long as the polyol has and continues to have at least one set of cis-hydroxyl groups. For example, glucose is a monosaccharide. Monosaccharides are any of several simple sugars having the formula C₆H₁₂O₆. Gluconic acid is the acid derivative of glucose. A gluconate, for example sodium gluconate, is the acid salt of gluconic acid. Accordingly, a gluconate is the acid salt derivative of a saccharide. Mannitol and sorbitol are both hexahydric alcohols with one hydroxyl group per carbon atom. Mannitol is derived by hydrogenating glucose, i.e., by hydrogenating the —CH═O group of glucose to the —CH₂—OH of mannitol. Sorbitol has the same number of carbons, hydrogens and oxygens as mannitol, it is therefore a diasteroisomer, differing in the spatial configuration of one carbon atom. One of the —OH's is arranged in the opposite direction from that of mannitol. Sorbitol is derived by pressure hydrogenation of dextrose (another name for glucose) with nickel catalysts. Accordingly, mannitol and sorbitol are both hydrogenation derivatives of glucose which is a monosaccharide or, generically, a saccharide. Suitable polyols may include those that provide adequate delay time and stabilize the fracturing fluid at the end use conditions of the fracturing process.

Examples of polyols are found in U.S. Pat. No. 5,877,127, which is herein incorporated by reference. Examples of such suitable polyols include fructose, sorbitol, gluconic acid and salts thereof, e.g., sodium gluconate, glucoheptonic acid and salts thereof, e.g., sodium glucoheptonate, mannitol, ribose, arabinose, and xylose.

When used, the polyol may be used in an amount of from 0 to about 1000 ppt (pounds per thousand gallons) (0 to about 120g/L) of fluid, more particularly from about 10 ppt (1.2 g/L) to about 100 ppt (12 g/L) of fluid. The polyol may be added to the fluid in various ways. It may be premixed with the aluminium crosslinker, or it may be added prior to the addition of the aluminium crosslinker.

Friction reducers may also be incorporated into fluids used in the invention. Any friction reducer may be used. Also, polymers such as polyacrylamide, polyisobutyl methacrylate, polymethyl methacrylate and polyisobutylene as well as water-soluble friction reducers such as guar gum, guar gum derivatives, hydrolyzed polyacrylamide, and polyethylene oxide may be used. Commercial drag reducing chemicals such as those sold by Conoco Inc. under the trademark “CDR” as described in U.S. Pat. No. 3,692,676 (Culter et al.) or drag reducers such as those sold by Chemlink designated under the trademarks “FLO 1003, 1004, 1005 & 1008” may also be used. These polymeric species added as friction reducers or viscosity index improvers may also act as fluid loss additives reducing or even eliminating the need for conventional fluid loss additives.

Breakers may optionally be used in some applications. The purpose of this component is to “break” or diminish the viscosity of the fluid so that this fluid is even more easily recovered from the formation during cleanup. With regard to breaking down viscosity, oxidizers, enzymes, or acids may be used. Breakers reduce the polymer's molecular weight by the action of an acid, an oxidizer, an enzyme, or some combination of these on the polymer itself. The breakers may include 0.1 (0.05 kg) to 20 pounds (9.1 kg) per thousands gallons (2785 liters) of conventional oxidizers such as ammonium persulfates, live or encapsulated, or potassium periodate, calcium peroxide, chlorites, and the like.

A fiber component may be included in the fluids used in the invention to achieve a variety of properties including improving particle suspension, and particle transport capabilities, as well as gas phase stability. Fibers used may be hydrophilic or hydrophobic in nature, but hydrophilic fibers are particularly useful. Fibers can be any fibrous material, such as, but not necessarily limited to, natural organic fibers, comminuted plant materials, synthetic polymer fibers (non-limiting examples including polyester, polyaramide, polyamide, novoloid or a novoloid-type polymer), fibrillated synthetic organic fibers, ceramic fibers, inorganic fibers, metal fibers, metal filaments, carbon fibers, glass fibers, ceramic fibers, natural polymer fibers, and any mixtures thereof. Particularly useful fibers are polyester fibers coated to be highly hydrophilic, such as, but not limited to, DACRON® polyethylene terephthalate (PET) Fibers available from Invista Corp. Wichita, Kans. Other examples of useful fibers include, but are not limited to, polylactic acid polyester fibers, polyglycolic acid polyester fibers, polyvinyl alcohol fibers, and the like. When used in fluids of the invention, the fiber component may be included at concentrations from about 1 to about 15 grams per liter of the liquid phase of the fluid, more particularly, the concentration of fibers may be from about 2 to about 12 grams per liter of liquid, and more particularly, from about 2 to about 10 grams per liter of liquid.

Embodiments of the invention may also include proppant particles that are substantially insoluble in the fluids of the formation. Proppant particles carried by the treatment fluid remain in the fracture created, thus propping open the fracture when the fracturing pressure is released and the well is put into production. Suitable proppant materials include, but are not limited to, sand, walnut shells, sintered bauxite, glass beads, ceramic materials, naturally occurring materials, or similar materials. Mixtures of proppants can be used as well. If sand is used, it is typically from about 20 to about 100 U.S. Standard Mesh (approx. 0.84 mm to 0.15 mm) in size. Naturally occurring materials may be underived and/or unprocessed naturally occurring materials, as well as materials based on naturally occurring materials that have been processed and/or derived. Suitable examples of naturally occurring particulate materials for use as proppants include, but are not necessarily limited to: ground or crushed shells of nuts such as walnut, coconut, pecan, almond, ivory nut, brazil nut, etc.; ground or crushed seed shells (including fruit pits) of seeds of fruits such as plum, olive, peach, cherry, apricot, etc.; ground or crushed seed shells of other plants such as maize (e.g., corn cobs or corn kernels), etc.; processed wood materials such as those derived from woods such as oak, hickory, walnut, poplar, mahogany, etc. including such woods that have been processed by grinding, chipping, or other form of particalization, processing, etc. Further information on nuts and composition thereof may be found in Encyclopedia of Chemical Technology, Edited by Raymond E. Kirk and Donald F. Othmer, Third Edition, John Wiley & Sons, Volume 16, pages 248-273 (entitled “Nuts”), Copyright 1981, which is incorporated herein by reference.

The concentration of proppant in the fluid can be any concentration known in the art, and, as an example, may be in the range of from about 0.05 to about 3 kilograms of proppant added per liter of liquid phase. Also, any of the proppant particles can further be coated with a resin to potentially improve the strength, clustering ability, and flow back properties of the proppant.

A foam component may also be incorporated into the fluid in certain embodiments of the invention. Compositions according to the invention may be foamed and energized well treatment fluids which contain “foamers,” which may include surfactants or blends of surfactants that facilitate the dispersion of a gas into the composition to form of small bubbles or droplets, and confer stability to the dispersion by retarding the coalescence or recombination of such bubbles or droplets. Foamed and energized fluids are generally described by their foam quality, i.e. the ratio of gas volume to the foam volume. If the foam quality is between 52% and 95%, the fluid is conventionally called a foamed fluid, and below 52%, an energized fluid. Compositions of the invention may include ingredients that form foams or energized fluids, such as, but not necessarily limited to, foaming surfactant, or blends of surfactants, and a gas which effectively forms a foam or energized fluid. In the present invention, nitrogen may be used as the gas component because carbon dioxide, which is also commonly used in foamed fluids, may lower the pH of the fluid below that required for the aluminum crosslinking agent to effectively crosslink the polymer in the divalent brines.

Embodiments of the invention may further contain other additives and chemicals that are known to be commonly used in oilfield applications by those skilled in the art. These include, but are not necessarily limited to, materials such as surfactants, breaking aids, high temperature fluid stabilizers (e.g. sodium thiosulfate), oxygen scavengers, alcohols (e.g. isopropanol), scale inhibitors, corrosion inhibitors, fluid-loss additives, iron control agents, bactericides, clay stabilizers, diesel, organic solvents, and the like. Surfactants or surface active agents may be added to the fluid to facilitate clean up of fracturing fluid after treatment. Also, surfactants may be included to optimize viscosity or to minimize the formation of stable emulsions that contain components of crude oil or other polymers. In the case of high bottomhole static temperature (>95° C.), additional high temperature stabilizer may be added to prevent oxidation or radical reaction, which may reduce fluid viscosity.

The aluminum crosslinked divalent heavy brine fluids of the invention may be used in hydraulic fracturing and in frac-pack operations. The crosslinked gels prepared as described above can be employed as high density fluids to create hydraulic fractures in formations and to transport proppant into those fractures to hold them open and increase productivity. The gels may also be used to transport gravel to place a gravel pack to prevent the transport of formation sand into the wellbore during production. Additionally, the gels may be used in a dual purpose ‘frac-pack’ applications where a hydraulic fracture is created and a pack is placed in the same operation.

The heavy brine fluids may be especially useful in deep and ultra deep wells where surface treating pressures are expected to be high. The heavy brine fluids of the invention may have a brine density of 8.5 lbs/gal (1 kg/L) to about 21 lbs/gal (2.52 kg/L) or more. The hydrostatic pressure generated by the weighted fluid may be able to lower the surface treating pressures.

The fact that the fluids may be formulated in heavy Ca-based brines also makes them a less costly and more readily available alternative to NaBr based fluids, currently used in aforementioned heavy brine applications. The higher densities provided by the divalent heavy brines may also make these fluids more effective than NaBr based fluids in inhibiting hydrate formation during flowback. The higher densities also make these fluids more effective for well control. Calcium-based brines are known to be more effective for controlling fines migration than sodium-based brines. If bridges are formed, the use of a weighted fluid through shunt tubes allows bypassing the bridges and effectively packing the voids. The addition of divalent ions, in particular calcium ions, may be used as a trigger to drastically alter the properties of the fluid. For example, a formulation prepared in water can be pumped as a lost circulation fluid, which would then gel when it contacts a calcium-containing brine. Additionally, fluids containing the aluminum crosslinking agent without the divalent ion content may be used to block or plug water-rich zones that may contain calcium ions to thereby form a gel in those zones, thus blocking these zones.

The procedural techniques for pumping fluids down a wellbore to treat a subterranean formation are well known. The person that designs such fracturing treatments is the person of ordinary skill to whom this disclosure is directed. That person has available many useful tools to help design and implement treatments, one of which is a computer program commonly referred to as a fracture simulation model (also known as fracture models, fracture simulators, and fracture placement models). One commercial fracture simulation model that is widely used by several service companies is known as FracCADE™. This commercial computer program is a fracture design, prediction, and treatment-monitoring program designed by Schlumberger, Ltd. All of the various fracture simulation models use information available to the treatment designer concerning the formation to be treated and the various treatment fluids (and additives) in the calculations, and the program output is a pumping schedule that is used to pump the fracture stimulation fluids into the wellbore. The text “Reservoir Stimulation,” Third Edition, Edited by Michael J. Economides and Kenneth G. Nolte, Published by John Wiley & Sons, (2000), is an excellent reference book for fracturing and other well treatments; it discusses fracture simulation models in Chapter 5 (page 5-28) and the Appendix for Chapter 5 (page A-15)), which are incorporated herein by reference.

The following examples serve to further illustrate the invention.

### EXAMPLES

### Example 1

Hydroxypropyl guar (available as Jaguar HP-8, Rhodia) in an amount of 0.5 grams was hydrated in 100 ml de-ionized (D.I.) water with 0.01 ml 37% HCl. The HCl was used to speed up hydration. Complete hydration was achieved in ˜5 minutes and the hydrated solution was placed in a centrifuge running at 3000 rpm for 10 minutes to remove entrained air. The centrifuged, hydrated polymer solution was placed in a blender and a vortex was created by stirring the solution. Subsequently, 3 ml of a 2% by weight NaAlO₂ solution (available from Special Products) was added to the mixture. The solution thickened but an elastic gel was not obtained. HCl and sodium hydroxide (NaOH) were then used to manipulate the pH of this mixture. It was found that a weak gel was obtained at pH values between about 5 to 9, while the gel lost elasticity at higher or lower pH values. FIG. 1 shows the steady shear viscosity of this formulation at three different pH values. At the intermediate pH, a weak gel was obtained. As a comparison, the viscosity of the same formulation (same polymer and crosslinker concentrations) in 9 ppg (1.078 kg/L) CaCl₂ brine is also presented. As can be seen, a much stronger gel is obtained in CaCl₂ brine than in water. This was an unexpected result and may indicate that calcium ions in the brine influence the effectiveness of the crosslinking species present in solution. All measurements presented in FIG. 1 were made on a Bohlin CVOR rheometer in a concentric cylinder geometry.

### Example 2

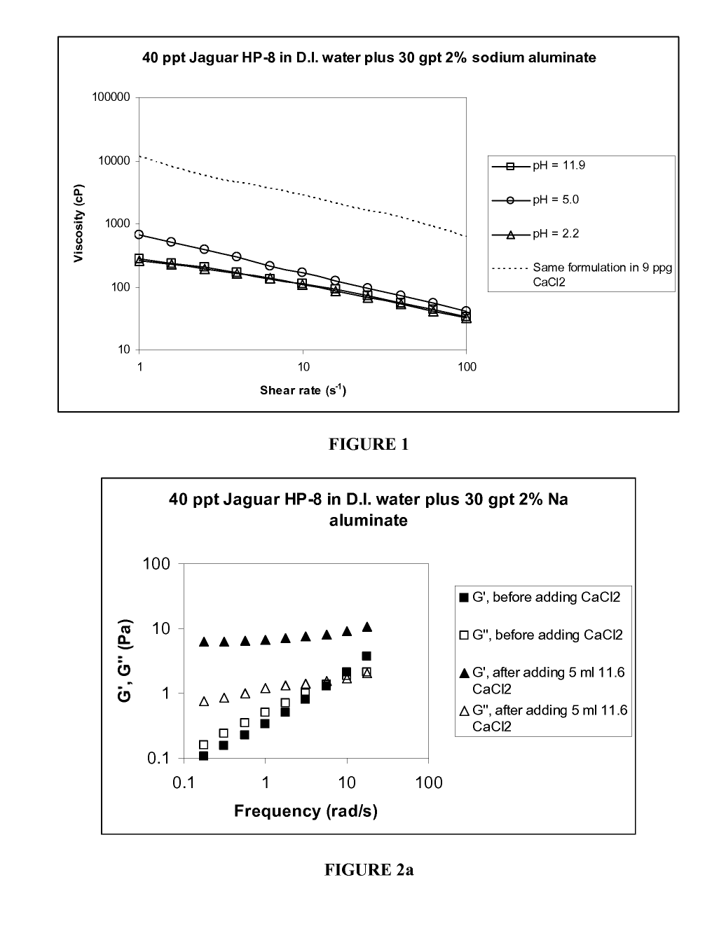

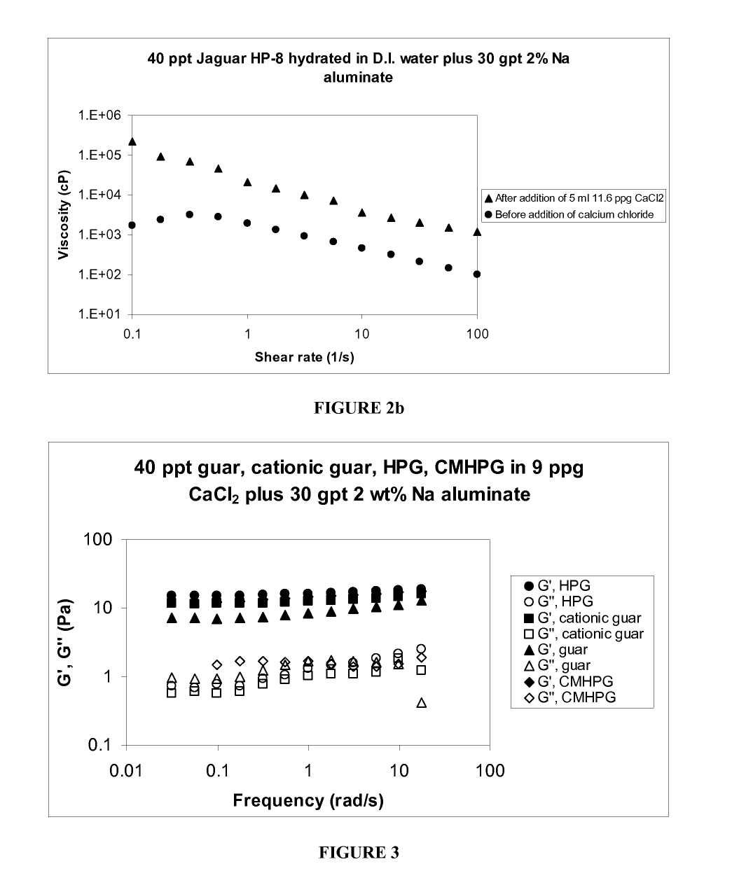

Hydroxypropyl guar in an amount of 0.5 grams was hydrated in 100 ml D.I. water with 0.01 ml 37% HCl. Complete hydration was achieved in ˜5 minutes and the hydrated solution was placed in a centrifuge running at 3000 rpm for 10 minutes to remove entrained air. The centrifuged, hydrated polymer solution was placed in a blender and a vortex was created by stirring the solution. Subsequently, 3 ml of a 2% NaAlO₂ solution was added to the mixture. The solution thickened but an elastic gel was not obtained. Using HCl and sodium hydroxide (NaOH), the pH of the fluid was varied between 4 and 12 and an elastic gel was not obtained at any pH value. Under all conditions, a mixture of “blobs” that was “pourable” was observed. Subsequently, 5 ml of an 11.6 ppg (1.39 kg/L) CaCl₂ brine was added to the mixture, resulting in an elastic gel. The dynamic elastic (G′) and viscous (G″) moduli of these two fluids are shown in FIG. 2a, evidencing that the latter is a solid-like elastic gel, while the former is not. Steady shear viscosities of the two fluids are shown in FIG. 2b.

### Example 3

Hydroxypropyl guar in an amount of 2.5 grams was hydrated in 500 ml 9 ppg (1.078 kg/L) CaCl₂ brine (prepared by diluting a 11.6 ppg (1.39 kg/L) CaCl₂ brine (available from M-I SWACO) with D.I. water) with 0.05 ml 37% HCl. Complete hydration was achieved in ˜10 minutes and the hydrated solution was placed in a centrifuge running at 3000 rpm for 10 minutes to remove entrained air. 100 ml of the centrifuged, hydrated polymer solution was placed in a blender and a vortex was created by stirring the solution. Subsequently, 3 ml of a 2 wt % NaAlO₂ solution was added to the mixture. The vortex closed in about 25 seconds and an elastic gel was obtained. In the examples, crosslinking is identified by the closing of the vortex. Room temperature dynamic (oscillatory) shear rheology (conducted at strain amplitude of 1% in the linear viscoelastic region) confirmed the elastic properties of this material, as evidenced by nearly frequency independent elastic (G′) and viscous (G″) moduli, with G′ an order of magnitude greater than G″, as shown in FIG. 3. The Theological measurements were performed on a Bohlin CVOR rheometer in a concentric cylinder geometry. Similar results were obtained when cationic guar (available as Jaguar C-17, from Rhodia), carboxymethylhydroxypropyl guar (CMHPG) and guar (both available from Hercules) were used under the same conditions, as shown in FIG. 3.

### Example 4

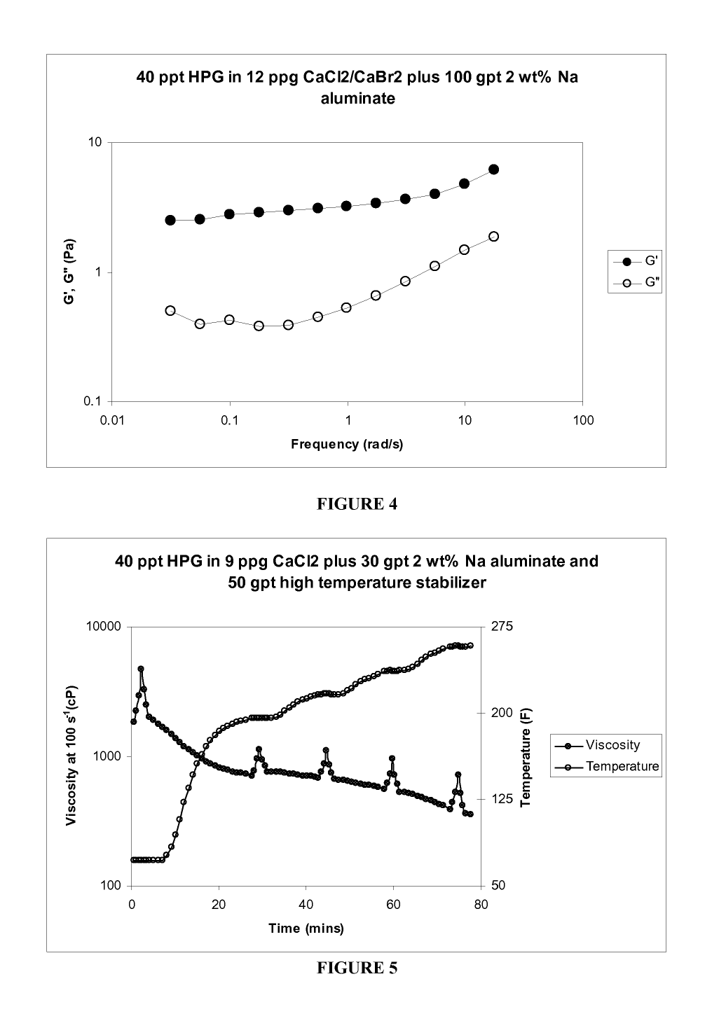

A cationic guar (available as Jaguar C-17, Rhodia) used in an amount of 0.5 grams was hydrated in 100 ml 12 ppg (1.44 kg/L) CaCl₂/CaBr₂ brine (prepared by mixing 11.6 ppg (1.39 kg/L) CaCl₂ and 14.2 ppg (1.7 kg/L) CaBr₂ brines) with 0.05 ml 37% HCl. Complete hydration was achieved in ˜20 minutes and the hydrated solution was placed in a centrifuge running at 3000 rpm for 10 minutes to remove entrained air. The centrifuged, hydrated polymer solution was placed in a blender and a vortex was created by stirring the solution. Subsequently, 10 ml of a 2 wt % NaAlO₂ solution was added to the mixture. The vortex closed in about 10 seconds and an elastic gel was obtained. Room temperature dynamic (oscillatory) shear rheology (conducted at strain amplitude of 1% in the linear viscoelastic region) confirmed the elastic properties of this material, as evidenced by nearly frequency independent elastic (G′) modulus, with G′ an order of magnitude greater than the viscous modulus (G″), as shown in FIG. 4. The rheological measurements were performed on a Bohlin CVOR rheometer in a concentric cylinder geometry.

### Example 5

Hydroxypropyl guar in an amount of 2.5 grams was hydrated in 500 ml of 9 ppg CaCl₂ brine (prepared by diluting a 11.6 ppg (1.39 kg/L) CaCl₂ brine with D.I. water) with 0.05 ml 37% HCl. Complete hydration was achieved in ˜10 minutes. The hydrated solution was placed in a centrifuge running at 3000 rpm for 10 minutes to remove entrained air. A 100 ml sample of the centrifuged, hydrated polymer solution was placed in a blender and 5 ml of high temperature gel stabilizer (available as 30% sodium thiosulfate in water) was added. A vortex was created by stirring the solution. Subsequently, 3 ml of a 2% NaAlO₂ solution was added to the mixture. The vortex closed in about 25 seconds and an elastic gel was obtained. This gel was loaded into a Fann 50 rheometer and its shear viscosity was measured at 100 s⁻¹ at temperatures of 70° F. (21° C.), 200° F. (93° C.), 220° F. (104° C.), 240° F. (116° C.), and 260° F. (127° C.). At each temperature, a shear ramp was run, wherein the viscosity was measured at shear rates of 100 s⁻¹, 75 s⁻¹, 50 s⁻¹, and 25 s⁻¹. The gel was continuously sheared at 100 s⁻¹ between temperatures. The gel had a viscosity of ˜300 mPa·s at 260° F. (127° C.), as shown in FIG. 5. These measurements were performed in a concentric cylinder geometry. Even though the high-temperature gel stabilizer increased gel stability at high temperatures, it was not required to prepare the gel.

### Example 6

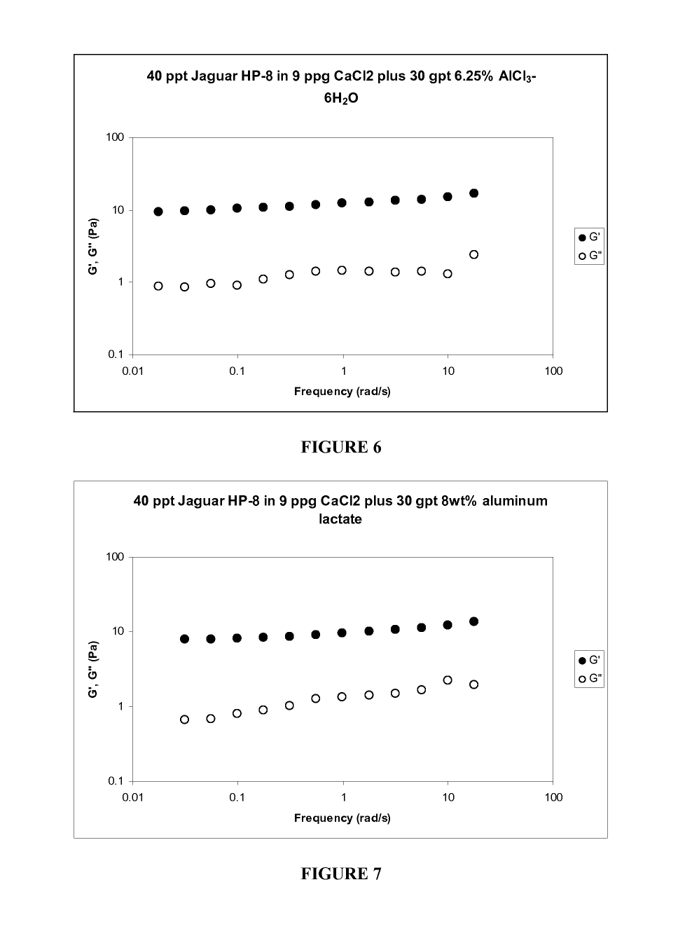

Hydroxypropyl guar in an amount of 0.5 grams was hydrated in 100 ml 9 ppg (1.078 kg/L) CaCl₂ brine with 0.01 ml 37% HCl. Complete hydration was achieved in ˜5 minutes and the hydrated solution was placed in a centrifuge running at 3000 rpm for 10 minutes to remove entrained air. The centrifuged, hydrated polymer solution was placed in a blender and a vortex was created by stirring the solution. Aluminum chloride hexahydrate (from Fischer Scientific) in an amount of 3 ml as a 6.25 wt. % solution was added to the hydrated polymer solution, resulting in a solution pH of ˜2.3. When the pH was raised to ˜8.8 by adding a pH modifier (tetraethylene pentamine), the vortex closed and an elastic gel was obtained. Room temperature dynamic (oscillatory) shear rheology (conducted at strain amplitude of 1% in the linear viscoelastic region) confirmed the elastic properties of this material, as evidenced by nearly frequency independent elastic (G′) and viscous (G″) moduli, with G′ an order of magnitude greater than G″, as shown in FIG. 6. The rheological measurements were performed on a Bohlin CVOR rheometer in a concentric cylinder geometry.

### Example 7

Hydroxypropyl guar in an amount of 0.5 grams was hydrated in 100 ml 9 ppg (1.078 kg/L) CaCl₂ brine with 0.01 ml 37% HCl. Complete hydration was achieved in ˜5 minutes and the hydrated solution was placed in a centrifuge running at 3000 rpm for 10 minutes to remove entrained air. The centrifuged, hydrated polymer solution was placed in a blender and a vortex was created by stirring the solution. Aluminum lactate (available from Aldrich) in an amount 3 ml as a 8 wt % solution was added to the hydrated polymer solution, resulting in a solution pH of ˜2.9. When the pH was raised to ˜8.6 by adding a pH modifier of tetraethylene pentamine, the vortex closed and an elastic gel was obtained. Room temperature dynamic (oscillatory) shear rheology (conducted at strain amplitude of 1% in the linear viscoelastic region) confirmed the elastic properties of this material, as evidenced by nearly frequency independent elastic (G′) and viscous (G″) moduli, with G′ an order of magnitude greater than G″, as shown in FIG. 7. The rheological measurements were performed on a Bohlin CVOR rheometer in a concentric cylinder geometry.

### Examples 8-13

The following examples demonstrate that polyols may be used to delay the crosslinking of polysaccharides by aluminum crosslinking agents in heavy brines. Further, these examples demonstrate that the recovered viscosity after high shear may be better in formulations containing polyols. Polymers were hydrated in brine, using HCl to accelerate the process. The polyol was added either separately or by premixing with the aluminum crosslinker. Crosslinking was identified by closure of a vortex created by stirring the hydrated polymer mixture in a Waring blender. Shear history tests were performed on a Grace rheometer by following a protocol that simulates the shear and temperature conditions encountered by a fluid during a hydraulic fracturing treatment. The conditions at different steps in the test are shown in Table 1 below.

TABLE 1

| | | Set temperature | |
|---|---|---|---|
| Step | Shear rate (s⁻¹) | (° C.) | Duration (mins) |
| 1 | 260 | 24 | 4 |
| 2 | 404 | 24 | 4 |
| 3 | 852 | 24 | 4 |
| 4 | 852 | 66 | 10 |
| 5 | 40 | 93 | 120 |

### Example 8

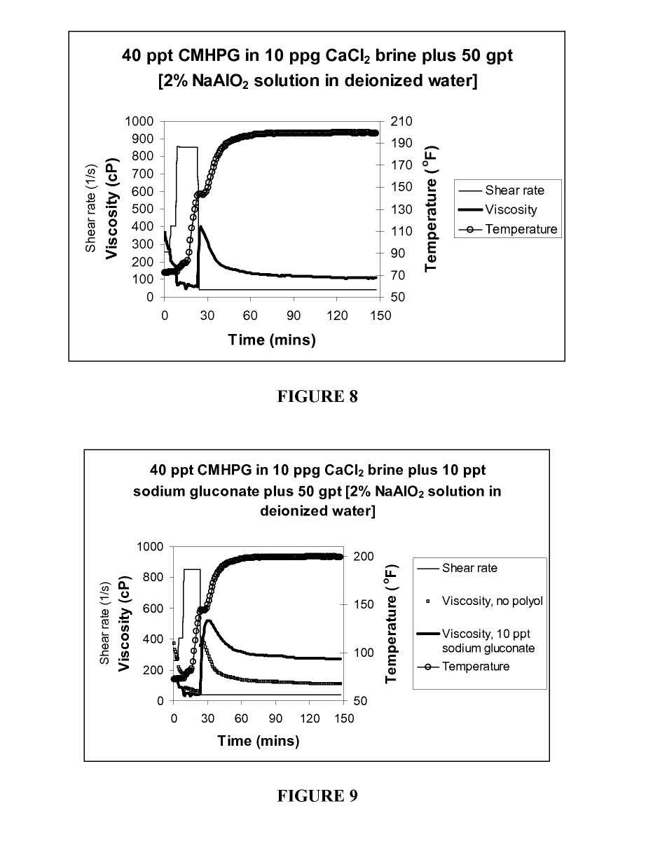

Carboxymethylhydroxypropyl guar (CMHPG, available from Hercules) was added to 10 ppg (1.2 kg/L) CaCl₂ brine at a concentration of ˜40 ppt (4.8 g/L), and a hydrated polymer mixture was prepared (˜0.1 gpt (0.01% by volume) of 37% hydrochloric acid, HCl was used to accelerate the rate of hydration). A 100 ml sample of this mixture was stirred in a Waring blender to create a vortex. A 5 ml solution of NaAlO₂ at 2 wt % (equivalent to ˜50 gpt (5% by volume) of total fluid volume) was added to the mixture and vortex closure was observed after 34 seconds. The pH of the crosslinked fluid was 7.7. A 50 ml sample of the crosslinked fluid was loaded into a Grace rheometer and a shear history test, as set forth in Table 1, was performed, with the results being presented in FIG. 8. This test simulates the flow of a fluid through a wellbore during a hydraulic fracturing treatment. The high shear regions represent the flow of the fluid through the wellbore (accompanied by a rise in temperature) and the final low shear region represents the flow of the fluid in the fracture.

### Example 9

Carboxymethylhydroxypropyl guar (CMHPG) was added to 10 ppg (1.2 kg/L) CaCl₂ brine at a concentration of ˜40 ppt (4.8 g/L), and a hydrated polymer mixture was prepared (˜0.1 gpt (0.01% by volume) of 37% HCl was used to accelerate the rate of hydration). A 100 ml sample of this mixture was stirred in a Waring blender to create a vortex. Sodium gluconate (available from Nalco) in an amount of 0.12 g as the polyol was added to the solution and allowed to mix for 2 minutes (this amounts to ˜10 ppt (1.2 g/L) sodium gluconate in the total fluid volume). A 5 ml solution of NaAlO₂ at 2 wt % (equivalent to ˜50 gpt (5% by volume) of fluid volume) was added to the mixture and vortex closure was observed after 43 seconds. The pH of the crosslinked fluid was 7.6. A 50 ml sample of the crosslinked fluid was loaded into a Grace rheometer and a shear history test was performed, with the results shown in FIG. 9. Results from Example 8 are shown in FIG. 9 for comparison. It is clear that the recovered viscosity is significantly higher in the formulation that contains sodium gluconate. Also apparent from the plot is the lower initial viscosity of the formulation containing sodium gluconate.

### Example 10

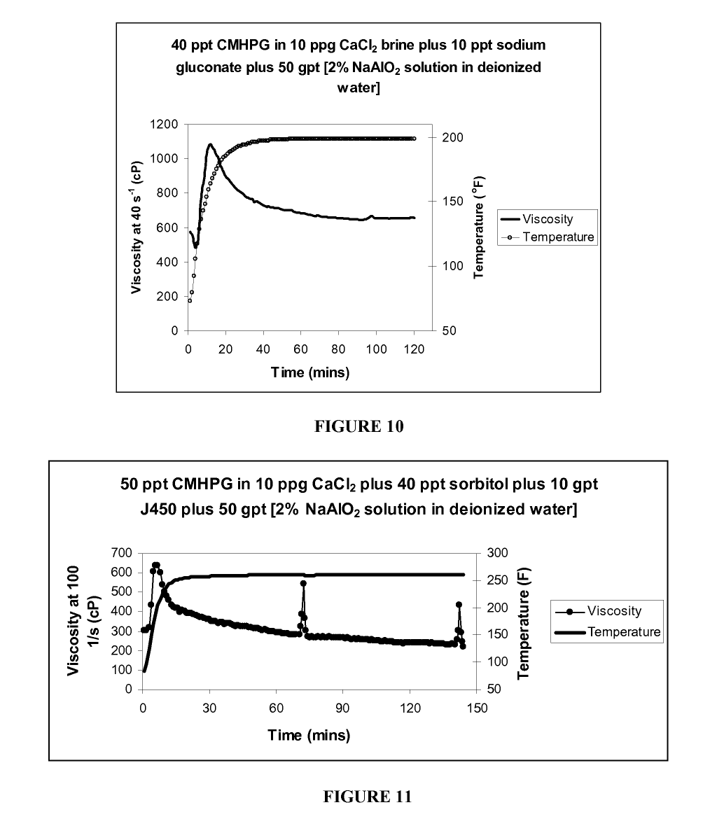

Carboxymethylhydroxypropyl guar (CMHPG) was added to 10 ppg (1.2 kg/L) CaCl₂ brine at a concentration of ˜40 ppt (4.8 g/L), and a hydrated polymer mixture was prepared (˜0.1 gpt (0.01% by volume) of 37% HCl was used to accelerate the rate of hydration). A 100 ml sample of this mixture was stirred in a Waring blender to create a vortex. Sodium gluconate in an amount of 0.12 g was added to the solution and allowed to mix for 2 minutes (this amounts to ˜10 ppt (1.2 g/L) of the fluid volume). A 5 ml solution of 2 wt % NaAlO₂ (equivalent to ˜50 gpt (5% by volume) of fluid volume) was added to the mixture and vortex closure was observed after 43 seconds. The pH of the crosslinked fluid was 7.6. A 50 ml sample of the crosslinked fluid was loaded into a Grace rheometer and the viscosity of the fluid at 200° F. (93° C.) at 40 s⁻¹ was measured as a function of time, with the results being shown in FIG. 10.

### Example 11

Carboxymethylhydroxypropyl guar (CMHPG) was added to 10 ppg (1.2 kg/L) CaCl₂ brine at a concentration of ˜50 ppt (6 g/L), and a hydrated polymer mixture was prepared (0.1 gpt (0.01% by volume) of 37% HCl was used to accelerate the rate of hydration). A 200 ml sample of this mixture was stirred in a Waring blender to create a vortex. Triethanolamine (as a high temperature stabilizer) was added in an amount of 2 ml to the mixture, followed by 0.96 g of sorbitol as the polyol, which was allowed to mix for 2 minutes (this amounts to ˜40 pounds of sorbitol per 1000 gallons of fluid volume (i.e. 4.8 g/L). A 5 ml solution of 2 wt % NaAlO₂ (equivalent to ˜50 gpt (5% by volume) of fluid volume) was added to the mixture and vortex closure was observed in less than 10 seconds. The pH of the crosslinked fluid was 7.6. A 50 ml sample of the crosslinked fluid was loaded into a Grace rheometer and the viscosity of the fluid at 260° F. (127° C.) and 100 s⁻¹ was measured as a function of time. The results are presented in FIG. 11.

### Example 12

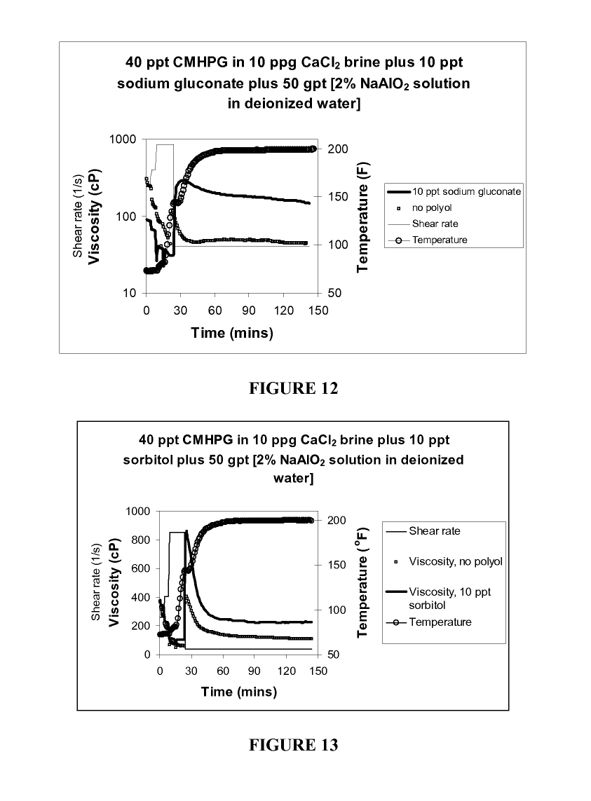

Hydroxypropyl guar was added to 10 ppg (1.2 kg/L) CaCl₂ brine at a concentration of ˜40 ppt (4.8 g/L), and a hydrated polymer mixture was prepared (˜0.1 gpt (0.01% by volume) of 37% HCl was used to accelerate the rate of hydration). A 100 ml sample of this mixture was stirred in a Waring blender to create a vortex. Sodium gluconate as the polyol in an amount of 0.09 g (this amounts to ˜7.5 ppt (0.9 g/L) of the total fluid volume) was added to the solution and allowed to mix for 2 minutes. A 5 ml solution of 2 wt % NaAlO₂ (equivalent to ˜50 gpt (5% by volume) of fluid volume) was added to the mixture and vortex closure was observed after 35 seconds. The pH of the crosslinked fluid was 7.5. A 50 ml sample of the crosslinked fluid was loaded into a Grace rheometer and a shear history test was performed, with the results presented in FIG. 12. Results from the same fluid prepared without any polyol are shown on the same plot for comparison. As in Example 9, it is clear that the recovered viscosity is significantly higher in the formulation that contains sodium gluconate. Also apparent from the plot is the lower initial viscosity of the formulation containing sodium gluconate.

### Example 13

Carboxymethylhydroxypropyl guar was added to 10 ppg (1.2 kg/L) CaCl₂ brine at a concentration of ˜40 ppt (4.8 g/L), and a hydrated polymer mixture was prepared (˜0.1 gpt (0.01% by volume) of 37% HCl was used to accelerate the rate of hydration). A 100 ml sample of this mixture was stirred in a Waring blender to create a vortex. Sorbitol in an amount of 0.12 g as the polyol was added to the solution and allowed to mix for 2 minutes (this amounts to ˜10 ppt (1.2 g/L) sodium gluconate in the total fluid volume). A 5 ml solution of 2% NaAlO₂ (equivalent to ˜50 gpt (5% by volume) of fluid volume) was added to the mixture and vortex closure was observed after 43 seconds. The pH of the crosslinked fluid was 7.6. A 50 ml sample of the crosslinked fluid was loaded into a Grace rheometer and a shear history test was performed, with the results presented in FIG. 13. Results from the same fluid prepared without any polyol are shown on the same plot for comparison.

### Example 14

Carboxymethylhydroxypropyl guar was added to 10 ppg (1.2 kg/L) CaCl₂ brine at a concentration of ˜40 ppt (4.8 g/L), and a hydrated polymer mixture was prepared (˜0.1 gpt (0.01% by volume) of 37% HCl was used to accelerate the rate of hydration). A 100 ml sample of this mixture was stirred in a Waring blender to create a vortex and various amounts of sodium gluconate as the polyol were added to the mixture and allowed to mix for 2 minutes. A 5 ml solution of 2% NaAlO₂ solution (equivalent to ˜50 gpt (5% by volume) of fluid volume) was added to the mixture. The resulting fluid was loaded into a Grace rheometer and a shear history test described in Table 1 was performed. The recovered viscosity values after 60 minutes at the final step of 40 s⁻¹ and 200° F. (93° C.) are summarized in Table 2 below for various amounts of sodium gluconate.

TABLE 2

| Concentration of sodium | Recovered viscosity, mPa-s at 40 s⁻¹ |
|---|---|
| gluconate (g/L) | and 93° C. after 60 minutes |
| 0 | 110 |
| 0.6 | 266 |
| 1.2 | 332 |
| 1.8 | 173 |
| 2.4 | 99 |

While the invention has been shown in only some of its forms, it should be apparent to those skilled in the art that it is not so limited, but is susceptible to various changes and modifications without departing from the scope of the invention. Accordingly, it is appropriate that the appended claims be construed broadly and in a manner consistent with the scope of the invention.

We claim:

1. A method of treating a subterranean formation penetrated by a wellbore, the method comprising:
providing a treatment fluid comprising a hydratable polymer, a divalent metal salt in an amount of at least about 0.25 mol/L and an aluminum crosslinking agent and providing the fluid with a pH of from about 5 or higher; and
causing the treatment fluid to contact the formation.

2. The method of claim 1, wherein:
the treatment fluid further comprises a polyol.

3. The method of claim 1, wherein:
the divalent metal salt is provided from at least one of a calcium salt and a zinc salt.

4. The method of claim 1, wherein:
the pH of the fluid is from about 7 to about 9.5.

5. The method of claim 1, wherein:
the treatment fluid is used to facilitate at least one of 1) reduction of pressure output requirement of surface equipment, 2) prevention or reduction of hydrate formation within the formation, 3) limiting lost fluid circulation and 4) blocking or plugging water-rich zones of the formation.

6. The method of claim 1, wherein:
the fluid has a density of at least about 9 lbs/gal (1.078 kg/L).

7. The method of claim 1, wherein:
the divalent metal salt is provided from at least one of calcium bromide, calcium chloride and zinc bromide.

8. The method of claim 1, wherein:
the polyol is provided from at least one of arabinose, fructose, mannitol, ribose, sorbitol, xylose, gluconic acid and its salts, glucoheptonic acid and its salts, and combinations of these.

9. The method of claim 1, wherein:
the aluminum crosslinking agent is selected from at least one of sodium aluminate, aluminum chloride, aluminum bromide, aluminum fluoride, aluminum iodide, aluminum carbide, aluminum ethoxide, aluminum isopropoxide, aluminum stearate, aluminum oxide, aluminum phosphate, bauzite (containing aluminum hydroxide (gibbsite), boehmite, kaolinite, diaspore), various aluminosilicates, aluminum lactate, aluminum acetate, aluminum citrate, aluminum chlorohydrate, aluminum chloride hexahydrate, aluminum acetyl acetonate, ammonium aluminum sulfate and aluminum metal.

10. The method of claim 1, wherein:
the aluminum crosslinking agent provides from about 1 to about 1000 parts per million of active aluminum by weight of the treatment fluid.

11. The method of claim 1, wherein:
the treatment fluid further comprises an acid.

12. The method of claim 2, wherein:
the polyol is present in an amount of from about 10 to about 100 ppt (1.2 g/L to 12 g/L).

13. The method of claim 1, wherein:
the treatment fluid further comprises a proppant.

14. A method of treating a subterranean formation penetrated by a wellbore, the method comprising:
providing a treatment fluid comprising a hydratable polymer, a calcium metal salt in an amount of at least about 0.25 mol/L, an acid, an aluminum crosslinking agent and a polyol and providing the fluid with a pH of from about 7 to about 9.5; and
introducing the treatment fluid into the wellbore.

15. The method of claim 14, wherein:
the treatment fluid is used to facilitate at least one of 1) reduction of pressure output requirement of surface equipment, 2) prevention or reduction of hydrate formation within the formation, 3) limiting lost fluid circulation and 4) blocking or plugging water-rich zones of the formation.

16. The method of claim 14, wherein:
the fluid has a density of at least about 9 lbs/gal (1.078 kg/L).

17. The method of claim 14, wherein:
the divalent metal salt is provided from at least one of calcium bromide, calcium chloride and zinc bromide.

18. The method of claim 14, wherein:
the polyol is provided from at least one of arabinose, fructose, mannitol, ribose, sorbitol, xylose, gluconic acid and its salts, glucoheptonic acid and its salts, and any combination thereof.

19. The method of claim 14, wherein:
the aluminum crosslinking agent is selected from at least one of sodium aluminate, aluminum chloride, aluminum bromide, aluminum fluoride, aluminum iodide, aluminum carbide, aluminum ethoxide, aluminum isopropoxide, aluminum stearate, aluminum oxide, aluminum phosphate, bauxite (containing aluminum hydroxide (gibbsite), boehmite, kaolinite, diaspore), various aluminosilicates, aluminum lactate, aluminum acetate, aluminum citrate, aluminum chlorohydrate, aluminum chloride hexahydrate, aluminum acetyl acetonate, ammonium aluminum sulfate and aluminum metal.

20. A method of treating a subterranean formation penetrated by a wellbore, the method comprising:
providing a first treatment fluid comprising an aqueous medium, a hydratable polymer, a divalent metal salt, and an aluminum crosslinking agent;
introducing the first treatment fluid into the wellbore and causing the first treatment fluid to contact the formation at a pressure equal to or greater than the fracture initiation pressure of the formation, whereby at least one fracture is created in the formation;
providing a second treatment fluid comprising an aqueous medium, a hydratable polymer, a divalent metal salt, a gravel component, and an aluminum crosslinking agent; and,
introducing the second treatment fluid into the wellbore and causing the second treatment fluid to contact the formation whereby a gravel pack is placed in the at least one fracture.
